(19) United States
(12) Patent Application Publication
(10) Pub. No.: US 2007/0107989 A1
(43) Pub. Date: May 17, 2007

(54) Forklift attachment

(76) Inventor: A. Wayne Berge, Tillamook, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 11/582,112

(22) Filed: Oct. 16, 2006

Related U.S. Application Data
(60) Provisional application No. 60/726,771, filed on Oct. 14, 2005.

(51) Int. Cl. B66F 9/12

(52) U.S. Cl. 187/237

(57) ABSTRACT

An apparatus that allows a user to compact garbage in a waste disposal receptacle to improve economic efficiency. Preferably, the apparatus is selectively mountable to a lifting apparatus of a lift truck so that it may be alternately lowered into, or raised out of, a waste receptacle, thereby compacting garbage in that receptacle.

### RELATED APPLICATIONS

This application claims the priority of U.S. provisional application Serial No. 60/726,771 filed on Oct. 14, 2005, the specification of which is incorporated herein by reference.

### BACKGROUND OF THE INVENTION

The present invention pertains to an apparatus that allows a user to compact garbage in a waste disposal bin to improve economic efficiency.

Garbage is typically stored in dumpsters prior to collection and disposal by waste disposal businesses, who usually charge by the dumpster or trip. For that reason, it is economical to store as much garbage in a dumpster as possible. One crude method of compacting garbage in a dumpster is for a person to climb into and stomp on the garbage, but this method may be dangerous, and if used in a business, possibly violate OSHA regulations. Another method is to insert heavy objects into the dumpster last, so as to crush lighter objects beneath, but this method is neither practical nor effective.

What is desired, therefore, is a method of, and apparatus for, crushing garbage in a dumpster or other similar container that is safe and efficient.

The foregoing and other objectives, features, and advantages of the invention will be more readily understood upon consideration of the following detailed description of the invention taken in conjunction with the accompanying drawings.

### BRIEF DESCRIPTION OF THE DRAWINGS

FIG. 1 shows a side view of a garbage compacting apparatus.

FIG. 2 shows an end view of the apparatus of FIG. 1.

FIG. 3 shows a first accessory selectively attachable to the apparatus of FIG. 1.

FIG. 4 shows a second accessory selectively attachable to the apparatus of FIG. 1.

### DETAILED DESCRIPTION

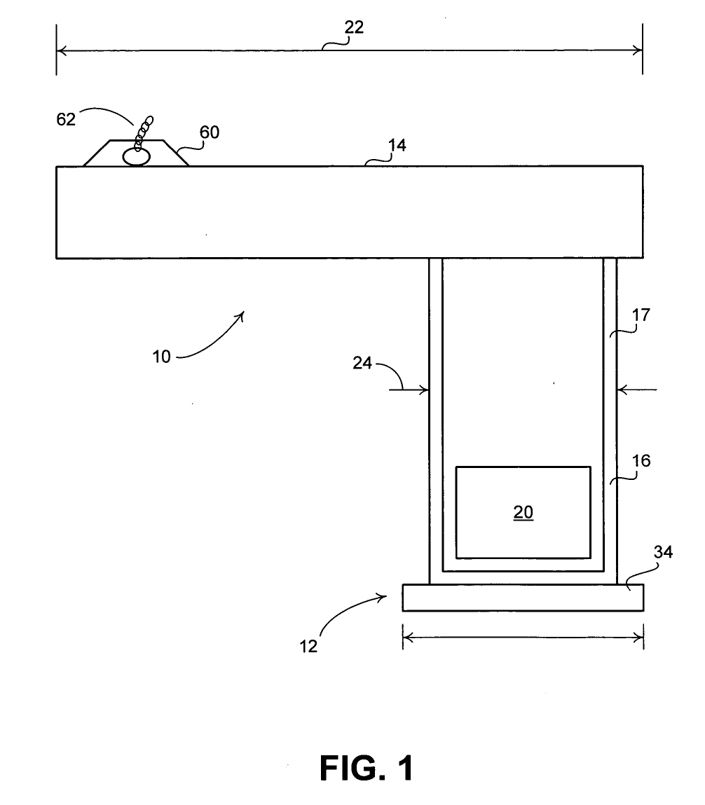

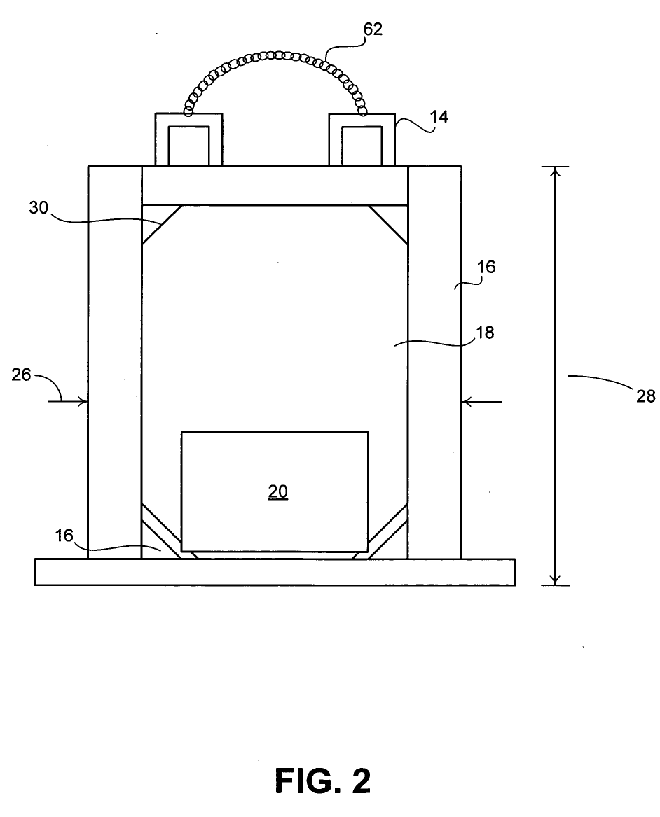

Referring to FIGS. 1 and 2, an apparatus 10 for compacting garbage may comprise a lower portion 12 and an upper engagement portion 14 matingly engageable with a lifting apparatus of a forklift and affixed to the top of the base portion 14. In one embodiment, as shown in FIGS. 1 and 2, the upper engagement portion 14 may comprise a pair of sleeves into which the forks of a lift truck may be inserted. Alternatively, the engagement portion 14 may be a member shaped to be gripped by a roll clamp of a lift truck, or may be any other member suitable to be engaged by a raisable member of a lift truck.

Preferably, the lower portion 12 has sufficient weight so that, when the apparatus 10 is raised by a lift truck and lowered into a dumpster or other similar container of garbage, the garbage will be compacted so that additional garbage may be placed in the container, and possibly compacted again, etc. Preferably, the lower portion 12 weighs at least 500 lbs. In other preferred embodiments, the lower portion 12 may weigh at least 750 lbs or more preferably at least 1000 lbs. In one preferred embodiment, the weight of the lower portion weighs 2100 lbs. It will be appreciated that the optimal or preferred weight of the lower portion 12 may vary with the type and/or amount of garbage to be compacted.

The lower portion 12, to which the upper engagement portion 14 is affixed, may comprise a housing 16 of metal angle iron 17 defining an enclosure 18 into which one or more weights 20 may be inserted. As shown in FIGS. 1 and 2, the weight 20 may be a single concrete block of the weight desired. Alternatively, the weights 20 may be bags of concrete sand, or other material, contained in any appropriate container. Still other embodiments may have lower portion 12 having an enclosure into which sand, concrete, etc., may be poured. Preferably, the housing 16 is configured to permit a user to insert a plurality of blocks 20 into the enclosure 18 to adjust the weight of the lower portion 12 to a desired amount and/or be configured to accept blocks of varying proportions and weights. In this manner, the apparatus 10 may be used in various circumstances where garbage is to be compacted at different weights. The tubes 17 of the housing 12 may be reinforced at the corners of the housing 16 by angle iron 30.

Garbage dumpsters or other receptacles have an assortment of shapes and sizes. Accordingly, to facilitate the use of the apparatus 10 with such an assortment of garbage receptacles, the apparatus 10 preferably has a lower portion 12 with a relatively small “footprint” i.e., horizontal cross section at the base, and an extended upper engagement portion 14 that has a length 22 that extends substantially beyond the length 24 of the lower portion 12. In this manner, the footprint of the lower portion 12 is small enough to fit into a variety of garbage receptacles with differing apertures, while the extended upper engagement portion 14 permits a forklift driver to move the lower portion 12 to most, and preferably all, areas within the receptacle to compact as much garbage as possible.

In a preferred embodiment, the lower portion 12 comprises a housing 16 having an approximately square transverse cross section, approximately three feet or less at each side, i.e. the length 24 and width 26 of the lower portion 12 are each three feet or less, while the upper engagement portion 14 has a length 22 of approximately five feet or more. Furthermore, the height 28 of the base portion 12 is also approximately at least three and one-half feet to permit garbage in a receptacle to be crushed by up to five feet. These dimensions are exemplary only, as dimensions of different sizes may be appropriate for receptacles having smaller or larger volumes. Also, in the preferred embodiment, the apparatus 10 includes a housing 16 made of tubes 17 each of steel and each approximately three inches in width. Alternatively, the tubes 17 may be made of aluminum, iron, composite material, or any other material suitable to support the desired weight or range of weights of the lower portion 12. Although the preferred embodiment described herein shows a lower portion 12 comprising a housing 16 defining an enclosure 18, it may in some circumstances be preferable to fashion a solid lower portion 12 of a desired material and weight, or other appropriate configuration.

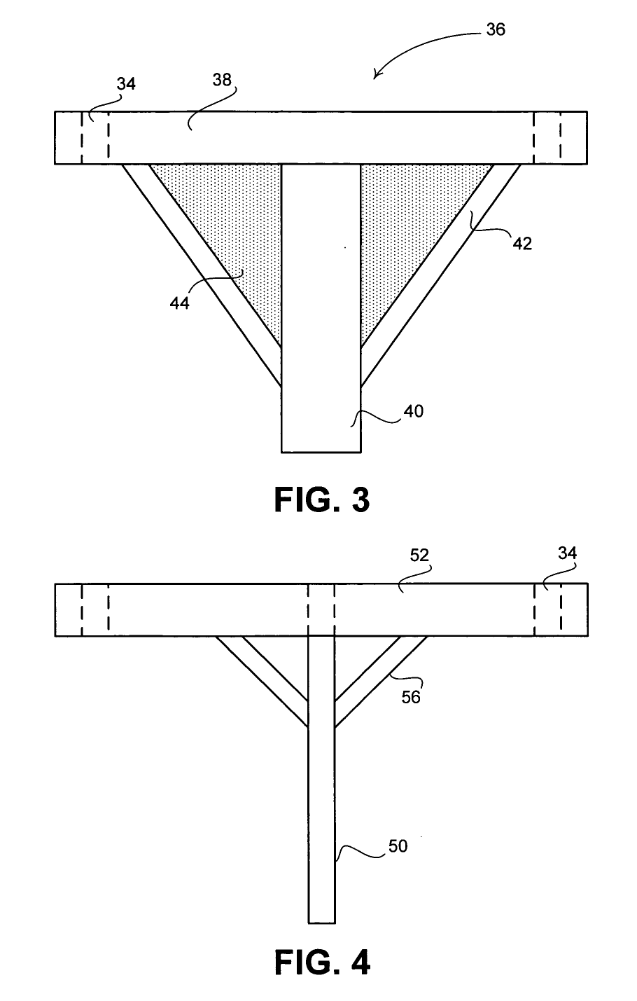

The housing 16 preferably includes a solid base member 32, which in the preferred embodiment is four feet square. The base member 32, being solid, facilitates the compacting of garbage in a receptacle. Furthermore, the base member 32 may preferably define a plurality of threaded openings 34 with which to selectively attach an accessory, such as those illustrated in FIGS. 3 and 4.

To secure the apparatus 10 securely to the lifting mechanism of a lift truck, such as a pair of forks, the upper engagement portion 14 may include one or more brackets 60 into which a chain 62 may be inserted and secured to the lift truck. Thus, for example, is the upper engagement portion is a pair of sleeves into which forks may be inserted, the chain 62 may prevent the apparatus 10 from sliding off of the forks and damaging property or injuring persons.

Oftentimes, pallets or other wood members are placed into a garbage receptacle, which because of their size and configuration, do not utilize the space in the receptacle very efficiently, so that it is often desirable to split or otherwise break apart the pallets or other wood members. Referring to FIG. 3, an accessory attachable to the apparatus 10 may comprise a wood splitting accessory 36 to perform this desired function. The wood splitting accessory 34 may have an upper plate 38 that is preferably proportioned to be mounted flush to the base member 32 of the housing 16. Like the base member 32, the upper plate 38 may include threaded openings 34 so that the wood splitting accessory 36 may be bolted to the apparatus 10. The wood splitting accessory may also include a splitting member 40 mounted perpendicular to the upper plate 38 with reinforcing members 42 supporting the splitting member 40 in its perpendicular position. The reinforcing members 42 preferably extend from a laterally outer position on the lower surface of the upper plate 38 to a position approximately three quarters of the length down the splitting member 40 so that, when the splitting member strikes a pallet or other wooden object, the splitting member 40 does not deform. Furthermore, such a configuration facilitates the simultaneous crushing of a stack of pallets or other wood members by pushing the split wood to the side. The plate 38, the splitting member 40, and the reinforcing members 42 are preferably each steel or other rigid material. The wood splitting accessory 36 may also include side caps 44 of flat steel.

Referring to FIG. 4, a second accessory 50 may be a metal crusher, which like the wood splitting accessory 36, may be used to crush metal objects to facilitate their efficient insertion into a garbage receptacle. The metal crusher 50 may also include an upper attachment plate 52 of metal with threaded bores 34 that facilitate selective attachment to the base 32 of the apparatus 10. The metal crusher 50 may include an elongate crushing member 54 laterally supported by reinforcing members 56 each attached at one end to the upper attachment plate 52 and at the other end to the crushing member 54. Unlike the wood splitting accessory 36, the reinforcing members 56 may be affixed to the elongate crushing member 54 at a position approximately one quarter of the length along the elongate crushing member and affixed to the upper attachment plate 52 at respective lateral locations along the inner lower surface of the upper attachment plate.

The terms and expressions that have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims that follow.

1. A forklift attachment comprising:
(a) a lower portion; and
(b) an upper engagement member matingly engageable with a lifting apparatus of a forklift, said engagement member affixed to the top of said base portion.

2. The forklift attachment of claim 1 where said lower portion weighs at least 500 lbs.

3. The forklift attachment of claim 1 where said lower portion weighs at least 750 lbs.

4. The forklift attachment of claim 1 where said lower portion weighs at least 1000 lbs.

5. The forklift attachment of claim 1 where said lower portion comprises a housing suitable to receive at least one concrete block.

6. The forklift attachment of claim 5 where said lower portion comprises a housing suitable to receive a plurality of concretes block such that the weight of said lower portion may be adjusted.

7. The forklift attachment of claim 5 where said lower portion comprises a housing suitable to receive concrete blocks of varying sizes.

8. The forklift attachment of claim 1 where said engagement member is a pair of sleeves each matingly engageable with a respective one of a pair of forklifts of said lift truck.

9. The forklift attachment of claim 8 where said sleeves extend substantially beyond a width of said lower portion.

10. The forklift attachment of claim 1 where said engagement member is shaped to be grippable by a roll clamp of a lift truck.

11. The forklift attachment of claim 1 where the height of said base portion is at least five feet.

12. The forklift attachment of claim 1 where the footprint of said base portion is less than 13 square feet.

13. The forklift attachment of claim 1 where the height of said base portion is at least five feet and the footprint of said base portion is less than 13 square feet.

14. The forklift attachment of claim 1 where said lower portion includes a base member selectively attachable to an accessory.

15. The forklift attachment of claim 14 where said accessory is suitable to split pallets.

16. The forklift attachment of claim 15 where said accessory includes a wedge portion.

17. The forklift attachment of claim 14 suitable to crush metal.

18. The forklift attachment of claim 1 including a safety member preventing said attachment from detaching from said lift truck.

19. The forklift attachment of claim 18 where said safety member is a chain.
